(19) United States
(12) Patent Application Publication
(10) Pub. No.: US 2020/0166808 A1
(43) Pub. Date: May 28, 2020

(54) OPTICAL MEMBER AND DISPLAY DEVICE INCLUDING THE SAME

(71) Applicant: Samsung Display Co. Ltd., Yongin-si (KR)

(72) Inventors: Sun Ho LEE, Hwaseong-si (KR); Hyun Jin MAENG, Seoul (KR)

(21) Appl. No.: 16/692,425

(22) Filed: Nov. 22, 2019

(30) Foreign Application Priority Data
Nov. 26, 2018 (KR) 10-2018-0147068

(51) Int. Cl. G02F 1/1335

(52) U.S. Cl. CPC G02F 1/133617

(57) ABSTRACT

An optical member includes a first film; a second film disposed to face the first film in a thickness direction; and a plurality of wavelength conversion members disposed between the first and second films and arranged in a direction perpendicular to the thickness direction, where each of the wavelength conversion members has flat surfaces. Flat surfaces of at least two of the wavelength conversion members are not parallel to each other.

This application claims priority to Korean Patent Application No. 10-2018-0147068, filed on Nov. 26, 2018, and all the benefits accruing therefrom under 35 U.S.C. § 119, the content of which in its entirety is herein incorporated by reference.

### BACKGROUND

### 1. Field

The disclosure relates to an optical member and a display device including the optical member.

### 2. Description of the Related Art

Liquid crystal display (“LCD”) devices have been of great importance in the field of information display technology. An LCD device typically includes liquid crystal molecules interposed between a pair of glass substrates, and display information by applying power via a power supply on or below the glass substrates for the liquid crystal molecules to transmit light.

Since LCD devices include a light-receiving panel that is incapable of generating light by themselves, but merely displays an image by adjusting the transmittance of light incident thereupon from an external source, additional devices for applying light to liquid crystal panels, i.e., backlight units, are included.

### SUMMARY

As a liquid crystal display (“LCD”) device becomes larger in size, viewing discrepancies may become greater when a viewer watches the center of the screen of the LCD device than when the viewer watches either side of the screen of the LCD device, and research has been conducted on how to reduce such viewing discrepancies. Recently, an LCD device having a curved display panel or a screen curved with respect to the center of the LCD device has been suggested to address viewing discrepancies.

Embodiments of the disclosure provide a high-curvature optical member that has a small thickness, but does not easily cause breakage.

Embodiments of the disclosure also provide a display device including a high-curvature optical member that has a small thickness, but does not easily cause breakage.

According to an embodiment of the disclosure, an optical member includes a first film; a second film disposed to face the first film in a thickness direction; and a plurality of wavelength conversion members disposed between the first and second films and arranged in a direction perpendicular to the thickness direction, where each of the wavelength conversion members has flat surfaces. In such an embodiment, the flat surfaces of at least two of the wavelength conversion members are not parallel to each other.

In an exemplary embodiment, the flat surfaces may include a bottom surface in contact with the first film and a top surface in contact with the second film and facing the bottom surface, and an area of the bottom surface may be larger than an area of the top surface.

In an exemplary embodiment, each of the wavelength conversion members may include a side surface disposed between, and at an inclination with respect to, the top and bottom surfaces, and an angle between the bottom surface and the side surface is an acute angle.

In an exemplary embodiment, each of the wavelength conversion members may have a trapezoidal cross-sectional shape.

In an exemplary embodiment, each of the wavelength conversion members may include a side surface disposed between the top and bottom surfaces, and the side surface is at least partially curved.

In an exemplary embodiment, the wavelength conversion members may include a first wavelength conversion member and a second wavelength conversion member disposed adjacent to the first wavelength conversion member, and an area of a top surface of the first wavelength conversion member may be larger than an area of a top surface of the second wavelength conversion member.

In an exemplary embodiment, an area of a bottom surface of the first wavelength conversion member may be the same as an area of a bottom surface of the second wavelength conversion member.

In an exemplary embodiment, a first angle between the bottom surface of the first wavelength conversion member and a side surface of the first wavelength conversion member may be greater than a second angle between the bottom surface of the second wavelength conversion member and a side surface of the second wavelength conversion member.

In an exemplary embodiment, an area of a bottom surface of the first wavelength conversion member may be larger than an area of a bottom surface of the second wavelength conversion member.

In an exemplary embodiment, a third angle between the bottom surface of the first wavelength conversion member and a side surface of the first wavelength conversion member may be the same as a fourth angle between the bottom surface of the second wavelength conversion member and a side surface of the second wavelength conversion member.

According to another embodiment of the disclosure, an optical member includes a first film; a second film disposed to face the first film in a thickness direction; and a plurality of wavelength conversion members disposed between the first and second films and arranged in a direction perpendicular to the thickness direction, where the optical member includes a curved area which is bent to have curvature in at least part thereof.

In an exemplary embodiment, each of the wavelength conversion members may include a glass plate and a wavelength conversion layer disposed on the glass plate.

In an exemplary embodiment, each of the wavelength conversion members may further include a passivation layer, and the wavelength conversion layer may be disposed between the glass plate and the passivation layer.

In an exemplary embodiment, the optical member may further include an air layer between the wavelength conversion members.

In an exemplary embodiment, a volume of the air layer in the curved area may smaller than a volume of the air layer in an area other than the curved area.

In an exemplary embodiment, the greater the curvature of the curve area is, the smaller the volume of the air layer in the cured area may be.

According to an embodiment of the disclosure, a display device comprises a lower film; an upper film disposed to face the lower film in a thickness direction; a plurality of wavelength conversion members disposed between the lower and upper films and arranged in a direction perpendicular to the thickness direction, where each of the wavelength conversion members has flat surfaces; a light source module disposed adjacent to the wavelength conversion members; and a display panel disposed above the wavelength conversion members. In such an embodiment, the flat surfaces of at least two of the wavelength conversion members are not parallel to each other, and the flat surfaces of each of the wavelength conversion members include a bottom surface in contact with the lower film and a top surface in contact with the upper film and facing the bottom surface.

In an exemplary embodiment, the light source module may be disposed below the wavelength conversion members, and the lower film may diffuse light emitted from the light source module.

In an exemplary embodiment, the light source module may be disposed adjacent to a side surface of the wavelength conversion members, and the lower film includes a reflective film or a reflective coating layer.

In an exemplary embodiment, each of the wavelength conversion members includes a glass plate and a wavelength conversion layer disposed on the glass plate, the light source module emits a blue light, and the wavelength conversion layer includes first wavelength conversion particles which convert the blue light into a green light and second wavelength conversion particles which convert the blue light into a red light.

According to embodiments of the disclosure, an optical member may be fabricated to have a small thickness and a high curvature structure without being easily damaged.

### BRIEF DESCRIPTION OF THE DRAWINGS

The above and other embodiments and features of the disclosure will become more apparent by describing in detail embodiments thereof with reference to the attached drawings, in which:

FIG. 1 is an assembled perspective view of a display device according to an embodiment of the disclosure;

FIG. 2 is an exploded perspective view of the display device of FIG. 1;

FIG. 3 is a plan view of an optical member according to an embodiment of the disclosure;

FIG. 4 is a cross-sectional view taken along line X1-X1′ of FIG. 3;

FIG. 5 is a cross-sectional view of a wavelength conversion member according to an embodiment of the disclosure;

FIG. 6 is an enlarged view of the portion Q1 in FIG. 5 illustrating how a wavelength conversion layer performs wavelength conversion;

FIG. 7 is a cross-sectional view illustrating the optical member of FIG. 3 in its bent state;

FIG. 8 is a plan view of an optical member according to an alternative embodiment of the disclosure;

FIG. 9 is a cross-sectional view taken along line X2-X2′ of FIG. 8;

FIG. 10 is a plan view of an optical member according to another alternative embodiment of the disclosure;

FIG. 11 is a cross-sectional view taken along line X3-X3′ of FIG. 10;

FIG. 12 is a plan view of an optical member according to another alternative embodiment of the disclosure;

FIG. 13 is a cross-sectional view taken along line X4-X4′ of FIG. 12;

FIG. 14 is a cross-sectional view taken along line X5-X5′ of FIG. 12;

FIGS. 15 and 16 are cross-sectional views of wavelength conversion members according to alternative embodiments of the disclosure;

FIG. 17 is a perspective view of an optical member according to another alternative embodiment of the disclosure; and

FIG. 18 is a cross-sectional view taken along line X6-X6′ of FIG. 17.

### DETAILED DESCRIPTION

The invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification. It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the invention. Similarly, the second element could also be termed the first element.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” “At least one of A and B” means “A and/or B.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system).

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the invention will be described with reference to the attached drawings.

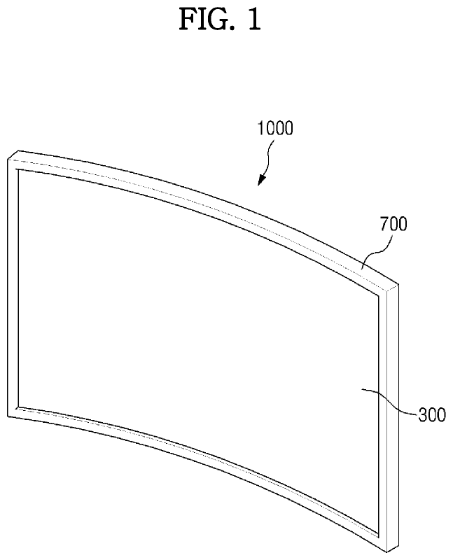

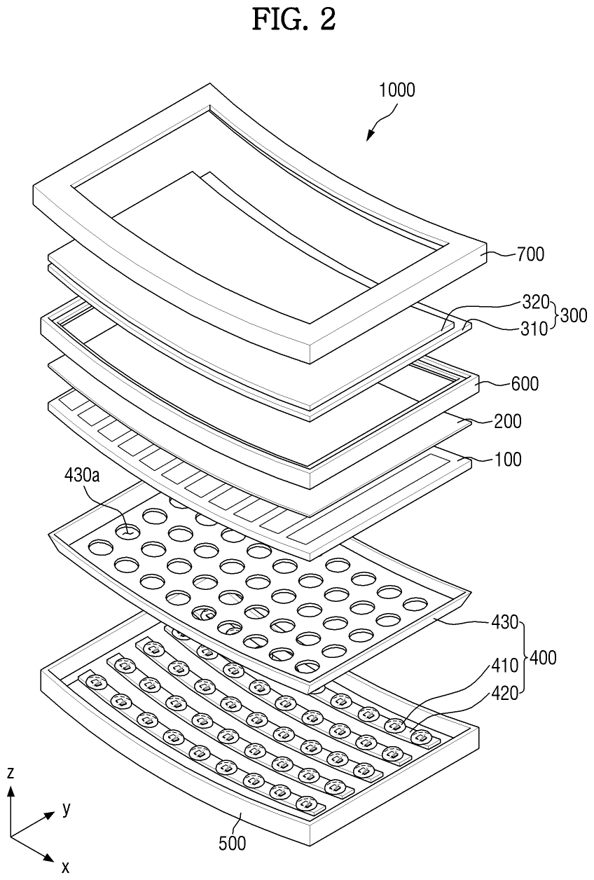

FIG. 1 is an assembled perspective view of a display device according to an embodiment of the disclosure. FIG. 2 is an exploded perspective view of the display device of FIG. 1.

Referring to FIGS. 1 and 2, an embodiment of the display device 1000 may be a curved display device having curvature at least in part thereof. The display device 1000 may have a curved shape with a single curvature or a curved shape with multiple curvatures, but the disclosure is not limited thereto. Alternatively, the display device 1000 may be a flat display device or a flexible display device that can be freely bent in various directions.

In an embodiment, as shown in FIG. 2, the display device 1000 includes an optical member 100, a display panel 300 disposed on the optical member 100, and a light source module 400 disposed below the optical member 100. The display device 1000 may further include one or more optical films 200 disposed between the optical member 100 and the display panel 300, and lower, middle and upper storage containers (e.g., chassis or frames) 500, 600 and 700 for containing the aforementioned elements of the display device 1000.

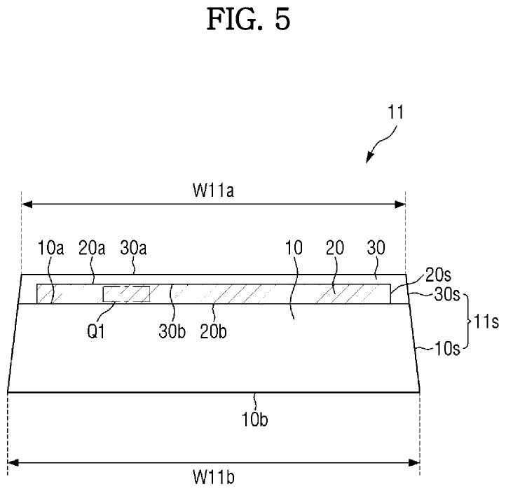

The optical member 100 may be a region on the emission path of the light source module 400 upon which light emitted from the light source module 400 is incident. At least some of the light incident upon the optical member 100 may be wavelength-converted or wavelength-shifted by a wavelength conversion layer 20 of FIG. 5, which is disposed in the optical member 100, and may thus be emitted toward the display panel 300. The optical member 100 may be disposed between the light source module 400 and the display panel 300 to improve the luminance uniformity of light emitted from the light source module 400 and incident upon the display panel 300. The structure of the optical member 100 will be described later in greater detail with reference to FIG. 5.

The display panel 300 is a panel for displaying an image. In one embodiment, for example, the display panel 300 may be a liquid crystal display (“LCD”) panel. Hereinafter, for convenience of description, embodiments where the display device 1000 is an LCD panel will be described in detail, but the disclosure is not limited thereto. Alternatively, various other display panels such as an electrowetting display panel or an electrophoretic display panel may be used as the display panel 300.

In an embodiment where the display device 1000 is a curved display device having curvature at least in part thereof, the display panel 300 may have a shape corresponding to the curvature of the display device 1000. The display panel 300 may include a pair of long sides that are opposite to each other and a pair of short sides that are opposite to each other. The long sides or the short sides of the display panel 300 may be curved to form curvature as a whole. In on embodiment, for example, the display panel 300 may be curved about a single axis along a second direction y, which intersects a first direction x as shown in FIG. 2, but the disclosure is not limited thereto. Alternatively, the display panel 300 may be curved about an axis along the first direction x. Here, a third direction z is a direction perpendicular to the first direction x and the second direction y, and the third direction z may be a thickness direction of the display device 1000 or elements therein. In some embodiments, the display panel 300 may be curved about two axes along both the first and second directions x and y. The first direction x may be a direction parallel to the long sides of the display panel 300, and the second direction y may be a direction parallel to the short sides of the display panel 300.

The display panel 300 may include a first display substrate 310, a second display substrate 320 opposite to the first display substrate 310, and a liquid crystal layer (not illustrated) disposed between the first and second display substrates 310 and 320. The first and second display substrates 310 and 320 may overlap each other when view from a plan view in the third direction z. In an embodiment, one of the first and second display substrates 310 and 320 may protrude or extend further from the other display substrate to provide a space for a driving chip or an external circuit board to be mounted when view from the plan view in the third direction z. In one embodiment, for example, the first display substrate 310 may protrude beyond the second display substrate 320, and a driving chip may be mounted on a protruding part of the first display substrate 310 in the form of a chip-on-glass (“COG”). However, the disclosure is not limited to this example. In such an embodiment, the sides of the first display substrate 310 except for those of the protruding part of the first display substrate 310 may be generally aligned with the sides of the second display substrate 320.

The display device 1000 may further include one or more optical films 200. The optical films 200 may be accommodated in a space surrounded by the middle storage container 600 and between the optical member 100 and the display panel 300. The optical films 200 may be disposed in the space between the optical member 100 and the display panel 300 to be spaced apart from the optical member 100 and the display panel 300. In one embodiment, for example, an inter-module coupling member (not illustrated) may be disposed between the optical member 100 and the display panel 300, and a side surface of the optical film 200 may be in contact with the inner side surface of the inter-module coupling member. The optical film 200 may be disposed apart from the optical member 100 or the display panel 300, but the disclosure is not limited thereto.

The optical films 200 may include a prism sheet, a diffusion sheet, a micro lens sheet, a lenticular sheet, a polarizing sheet, a reflective polarizing sheet, a phase difference sheet, and/or the like. The display device 1000 may include a plurality of optical films 200 of a same type or different types. In an embodiment where a plurality of optical films 200 are provided, the plurality of optical films 200 may be arranged to overlap one another. In such an embodiment, the plurality of optical films 200 may be spaced apart from one another with gaps therebetween, but the disclosure is not limited thereto. Alternatively, the plurality of optical films 200 may be attached to one another without gaps therebetween.

The light source module 400 may be disposed below the display panel 300 and the optical member 100. The light source module 400 may provide light toward the optical member 100, and the optical member 100 may provide light toward the display panel 300. IN such an embodiment, the display panel 300 may display an image by receiving light from the light source module 400 and from the optical member 100.

The light source module 400 may be disposed in the lower storage container 500, and the lower storage container 500 may include a recessed part (not shown) in which the light source module 400 is disposed.

The light source module 400 may include a plurality of point light sources and printed circuit boards 420. The point light sources may be light-emitting diode (“LED”) light sources 410. The LED light sources 410 may be mounted on the printed circuit boards 420. The LED light sources 410 may emit a blue light. In one embodiment, for example, the wavelength band of the blue light emitted from the LED light sources 410 may be in a range of about 400 nanometers (nm) to about 500 nm.

In an embodiment, as illustrated in FIG. 2, the LED light sources 410 may be top emission LEDs that emit light through the top surfaces thereof. The printed circuit boards 420 may be disposed on the bottom surface of the lower storage container 500.

The light source module 400 may further include a reflector 430 disposed on the LED light sources 410. The reflector 430 upwardly reflects light directed downwardly, among beams of light emitted from the LED light sources 410. The reflector 430 may include openings 430a corresponding to the LED light sources 410, respectively. In one embodiment, for example, the number of the openings 430a is equal to the number of the LED light sources 410.

The lower storage container 500 may be bent to have the same curvature as the display panel 300 and the optical member 100. The lower storage container 500 may be disposed below the display panel 300 and may be, for example, a bottom chassis. The lower storage container 500 may accommodate the light source module 400 and the optical member 100, as described above, and may further accommodate the optical films 200 and the display panel 300.

The middle storage container 600 has a shape corresponding to the curvature of the display panel 300. The middle storage container 600 may be disposed below the display panel 300 and may be, for example, a mold frame or a middle mold. The middle storage container 600 may be fastened and fixed to the lower storage container 500. The middle storage container 600 may accommodate the display panel 300, the optical films 200 and the optical member 100.

The upper storage container 700 also has a shape corresponding to the curvature of the display panel 300. The upper storage container 700 may be disposed above the display panel 300 and may be, for example, a top chassis or a bezel. The upper storage container 700 includes an open window and covers and thereby protects the edges of the display panel 300. The upper storage container 700 may be coupled to the lower storage container 500 to fix the aforementioned elements of the display device 1000.

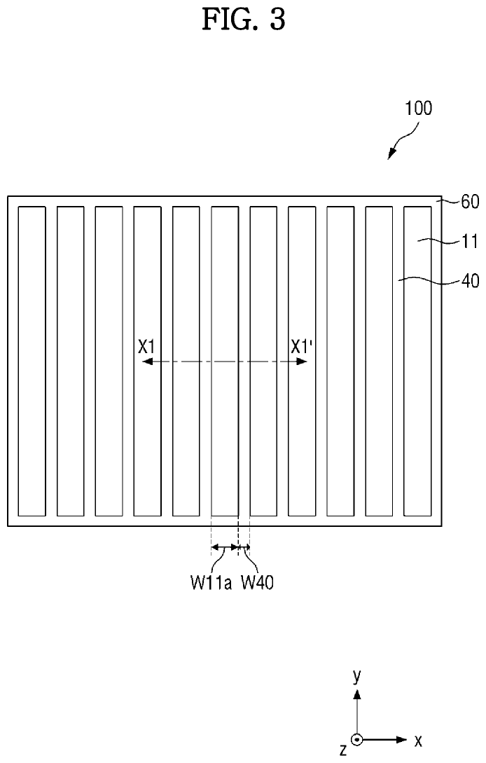

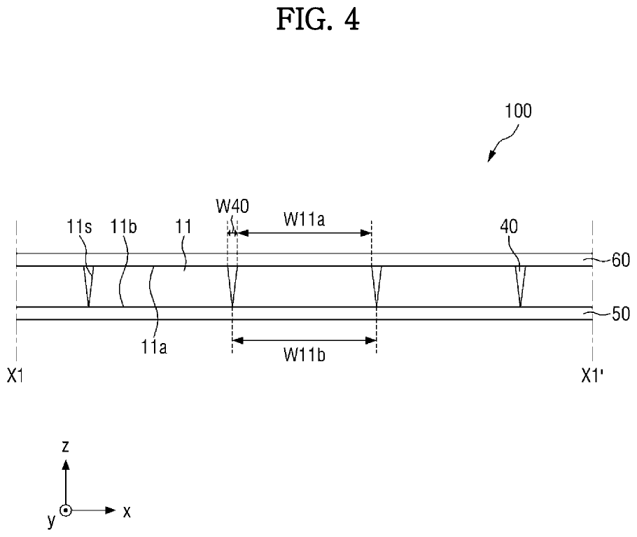

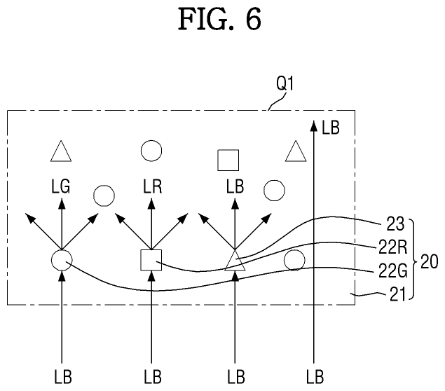

FIG. 3 is a plan view of an optical member according to an embodiment of the disclosure. FIG. 4 is a cross-sectional view taken along line X1-X1′ of FIG. 3. FIG. 5 is a cross-sectional view of a wavelength conversion member according to an embodiment of the disclosure. FIG. 6 is an enlarged view of the portion Q1 in FIG. 5 illustrating how a wavelength conversion layer performs wavelength conversion.

Referring to FIGS. 3 through 5, an embodiment of an optical member 100 may include a plurality of wavelength conversion members 11, a lower film 50 disposed below the wavelength conversion members 11, and an upper film 60 disposed above the wavelength conversion members 11. The wavelength conversion members 11 may be fixed by the lower and upper films 50 and 60, such that the wavelength conversion members 11 may be allowed to maintain a predetermined shape. In an embodiment where the display panel 300 is bent to have a predetermined curvature, the optical member 100 may be bent in accordance with the curvature of the display panel 300.

The wavelength conversion members 11, which are included in the optical member 100, may be apart from one another with a predetermined distance in a first direction x. In an embodiment, as shown in FIG. 4, an upper surface of the wavelength conversion members 11 may be spaced apart from each other. The first direction x may be a direction perpendicular to the thickness direction of the lower and upper films 50 and 60, which will be described later. In such an embodiment, the wavelength conversion members 11 may be disposed to extend along a second direction y, which intersects the first direction x in a plan view. An air layer 40 may be defined in the gaps between the wavelength conversion members 11. The air layer 40 may disappear or shrink when the optical member 100 is bent to have a predetermined curvature.

Top and bottom surfaces 11a and 11b of each of the wavelength conversion members 11 may be flat surfaces that fall on their respective single planes, and the planes where the top and bottom surfaces 11a and 11b are located may be generally parallel to each other so that the wavelength conversion members may have a generally uniform thickness. However, the disclosure is not limited to this. Alternatively, each of the top and bottom surfaces 11a and 11b may have multiple planes, or the planes where the top and bottom surfaces 11a and 11b are located may intersect each other.

When the optical member 100 is yet to be bent or in a flat state, the top and bottom surfaces 11a and 11b may be parallel to each other. However, when the optical member 100 is bent to have a predetermined curvature or in a bent state, the top and bottom surfaces 11a and 11b may not be parallel to each other.

Each of the wavelength conversion members 11 may include side surfaces 11s between the top and bottom surfaces 11a and 11b thereof. The side surfaces 11s may be flat surfaces, as illustrated in FIG. 4. Alternatively, the side surfaces 11s may be curved surfaces.

In an embodiment, a width W11a of the top surfaces 11a of the wavelength conversion members 11 may be less than a width W11b of the bottom surfaces 11b of the wavelength conversion members 11. In such an embodiment, the side surfaces 11s, which are formed between the top and bottom surfaces 11a and 11b, may be inclined with respect to the top and bottom surfaces 11a and 11b. In one embodiment, for example, in a cross-sectional view, the top and bottom surfaces 11a and 11b and both side surfaces of each of the wavelength conversion members 11 may form a trapezoidal shape.

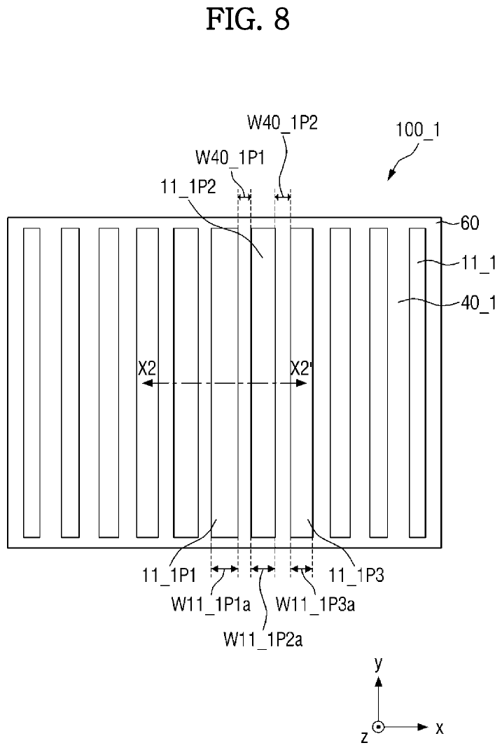

In an embodiment, the top surfaces 11a of the wavelength conversion members 11 may have a same width, i.e., the width W11a, as each other. The bottom surfaces 11b of the wavelength conversion members 11 may have a same width, i.e., the width W11b, as each other. In In such an embodiment, in a cross-sectional view, the wavelength conversion members 11 may all have a same shape as each other, but the disclosure is not limited thereto. In some embodiments, the wavelength conversion members 11 may have different cross-sectional shapes, and this will be described later with reference to FIGS. 8 to 11. First, an embodiment of the wavelength conversion members 11 having the same cross-sectional shape will hereinafter be described in detail.

In such an embodiment, as illustrated in FIG. 4, the bottom surfaces 11b of the wavelength conversion members 11 may be disposed to be in contact with one another. Alternatively, the bottom surfaces 11b of the wavelength conversion members 11 may be spaced apart from one another with a predetermined distance. As described above, the air layer 40 may be defined or formed between the wavelength conversion member 11, and the top surfaces 11a of the wavelength conversion members 11 may be spaced apart from one another with a distance W40 therebetween. The distances between the top surfaces 11a of the wavelength conversion members 11 may all be the same as each other, i.e., the distance W40.

In an embodiment where the wavelength conversion members 11 have a same cross-sectional shape as each other and the top surfaces 11a of the wavelength conversion members 11 are spaced apart from one another by a same distance (i.e., the distance W40), the optical member 100 may be bent to have a uniform curvature as a whole. In an alternative embodiment, where the wavelength conversion members 11 have different cross-sectional shapes and the top surfaces 11a of the wavelength conversion members 11 are apart from one another by different distances, the curvature of the optical member 100 may differ from one area to another area of the optical member 100.

In an embodiment, as shown in FIG. 5, each of the wavelength conversion members 11 may include a glass plate 10, a wavelength conversion layer 20, and a passivation layer 30 disposed on the wavelength conversion layer 20. The glass plate 10, the wavelength conversion layer 20 and the passivation layer 30 may be incorporated into a single wavelength conversion member 11. In such an embodiment, the top surface 11a of the single wavelength conversion member 11 may be defined by a top surface 30a of the passivation layer 30, the bottom surface 11b of the single wavelength conversion member 11 may be defined by a bottom surface 10b of the glass plate 10, and the side surfaces 11s of the single wavelength conversion member 11 may be defined by side surfaces 10s of the glass plate 10 and side surfaces 30s of the passivation layer 30.

For convenience of illustration, the thicknesses of the wavelength conversion layer 20 and the passivation layer 30 are exaggerated in FIGS. 3 through 6, but actually, the wavelength conversion layer 20 and the passivation layer 30 may both be substantially thin. That is, the shape of each of the wavelength conversion members 11 may be generally similar to the shape of the glass plate 10.

The glass plate 10 may provide a path that light emitted from the light source module 400 can travel along. The glass plate 10 may provide a space in which the wavelength conversion layer 20 is disposed.

The glass plate 10 may be generally in the shape of a polygonal column. The glass plate 10 may include top and bottom surfaces 10a and 10b that are parallel to each other, and side surfaces 10s that are disposed between the top and bottom surfaces 10a and 10b and are inclined with respect to the top and bottom surfaces 10a and 10b. The width of the top surface 10a may be less than the width of the bottom surface 10b. In such an embodiment, the glass plate 10 may have a trapezoidal shape in a cross-sectional view.

The glass plate 10 may be an optical plate including or formed of glass, but the disclosure is not limited thereto. Alternatively, the glass plate 10 may include or be formed of an inorganic material other than glass. The glass plate 10 may seal the wavelength conversion layer 20, which is disposed between the glass plate 10 and the passivation layer 30, through inorganic-inorganic bonding with the passivation layer 30, which will be described later.

The wavelength conversion layer 20 and the passivation layer 30 may be disposed on the top surface 10a of the glass plate 10.

The wavelength conversion layer 20 may be disposed or formed directly on the top surface 10a of the glass plate 10, and the bottom surface 20b of the wavelength conversion layer 20 may be in direct contact with the top surface 10a of the glass plate 10. In one embodiment, for example, the side surfaces 20s of the wavelength conversion layer 20 may be disposed inside the boundaries between the top surface 10a and the side surfaces 10s of the glass plate 10. In such an embodiment, the wavelength conversion layer 20 may cover most of the top surface 10a of the glass plate 10 and may expose edge portions of the glass plate 10. In such an embodiment, the side surfaces 10s of the glass plate 10 may protrude beyond the side surfaces 20s of the wavelength conversion layer 20. Parts of the top surface 10a of the glass plate 10, exposed by the wavelength conversion layer 20, may provide a space for an effective sealing structure or for allowing the wavelength conversion layer 20 to be stably covered by the passivation layer 30.

The side surfaces of the wavelength conversion layer 20 may have an inclination angle less than 90° with respect to the top surface 10a of the glass plate 10, instead of being perpendicular to the top surface 10a of the glass plate 10. Alternatively, the side surfaces 20s of the wavelength conversion layer 20 may be perpendicular to the top surface 10a of the glass plate 10, instead of having an inclination angle with respect to the top surface 10a of the glass plate 10.

The wavelength conversion layer 20 may be formed by, for example, a coating method. In one embodiment, for example, the wavelength conversion layer 20 may be formed by slit-coating a wavelength conversion composition on the glass plate 10 and drying and curing the wavelength conversion composition, but the disclosure is not limited thereto. In such an embodiment, various deposition methods may be used to form the wavelength conversion layer 20.

FIG. 6 is an enlarged partial cross-sectional view illustrating how a wavelength conversion layer performs wavelength conversion. An embodiment of the wavelength conversion layer 20 will hereinafter be described with reference to FIG. 6.

Referring to FIG. 6, an embodiment of the wavelength conversion layer 20 may be disposed on the top surface 10a of the glass plate 10 and may convert or shift the wavelength of at least some light incident upon the wavelength conversion layer 20. The wavelength conversion layer 20 may include a binder layer 21 and wavelength conversion particles 22 dispersed in the binder layer 21. The wavelength conversion layer 20 may further include scattering particles 23 dispersed in the binder layer 21.

The binder layer 21, which is a medium in which the wavelength conversion particles 22 are dispersed, may include at least one of various resin compositions, but the disclosure is not limited thereto. Any type of medium that disperses the wavelength conversion particles 22 and/or the scattering particles 23 therein may be referred to as the binder layer 21 regardless of its actual name, additional function(s), and composition.

The wavelength conversion particles 22, which are particles that converts the wavelength of incident light, may be, for example, quantum dots, a fluorescent material or a phosphor material. For convenience of description, an embodiment where the wavelength conversion particles 22 are quantum dots will hereinafter be described in detail, but the disclosure is not limited thereto.

The quantum dots are a material having a nanometer-sized crystal structure and consist of several hundreds to thousands of atoms. Due to the small size of the quantum dots, an energy band gap increases, i.e., a quantum confinement effect occurs. In response to light with higher energy than the energy band gap being incident upon quantum dots, the quantum dots absorb the incident light to be excited, emit light of a predetermined wavelength, and then fall to the ground state. The light emitted by the quantum dots has a value corresponding to the energy band gap. The emission characteristics of the quantum dots, resulting from quantum confinement, can be controlled by adjusting the size and the composition of the quantum dots.

The quantum dots may include at least one of, for example, a Group II-VI compound, a Group II-V compound, a Group III-VI compound, a Group III-V compound, a Group IV-VI compound, a Group compound, a Group II-IV-VI compound, and a Group II-IV-V compound.

Each of the quantum dots may include a core and a shell surrounding or overcoating the core. The core may include at least one of, for example, CdS, CdSe, CdTe, ZnS, ZnSe, ZnTe, GaN, GaP, GaAs, GaSb, AlN, AlP, AlAs, AlSb, InP, InAs, InSb, SiC, Ca, Se, In, P, Fe, Pt, Ni, Co, Al, Ag, Au, Cu, FePt, Fe₂O₃, Fe₃O₄, Si, and Ge. The sell may include at least one of, for example, ZnS, ZnSe, ZnSeS, ZnTe, CdS, CdSe, CdTe, HgS, HgSe, HgTe, AlN, AlP, AlAs, AlSb, GaN, GaP, GaAs, GaSb, GaSe, InN, InP, InGaP, InAs, InSb, TiN, TiP, TiAs, TiSb, PbS, PbSe, and PbTe.

The wavelength conversion particles 22 may include a plurality of groups of wavelength conversion particles 22 for converting incident light into different wavelengths. In one embodiment, for example, the wavelength conversion particles 22 may include first wavelength conversion particles 22G that convert the wavelength of incident light into a first wavelength and second wavelength conversion particles 22R that convert the wavelength of the incident light into a second wavelength. In an embodiment, light emitted from the light source module 400 to be incident upon the wavelength conversion particles 22 may be light of a blue wavelength, the first wavelength may be a green wavelength, and the second wavelength may be a red wavelength. In one embodiment, for example, the blue wavelength may have a peak in a range of about 430 nm to about 470 nm, the green wavelength may have a peak in a range of about 520 nm to about 570 nm, and the red wavelength may have a peak in a range of about 620 nm to about 670 nm. However, the blue, green, and red wavelengths are not particularly limited and should be understood as encompassing all wavelength bands that are typically perceived as blue, green, and red wavelengths.

In such an embodiment, some blue light LB incident upon the wavelength conversion layer 20 may be incident upon the first wavelength conversion particles 22G to be converted into, and emitted as, green light through the wavelength conversion layer 20, other blue light LB incident upon the wavelength conversion layer 20 may be incident upon the second wavelength conversion particles 22R to be converted into, and emitted as, red light through the wavelength conversion layer 20, and still other blue light LB incident upon the wavelength conversion layer 20 may be emitted as it is without being incident upon the first wavelength conversion particles 22G or the second wavelength conversion particles 22R. Thus, light transmitted through the wavelength conversion layer 20 may include all blue light LB, green light LG, and red light LR. By appropriately controlling the ratio of emitted light of different colors, a white light or light of various other colors can be displayed. Beams of light converted by the wavelength conversion layer 20 are concentrated on narrow wavelength bands and thus have a sharp spectrum with a narrow half width at half maximum. Accordingly, color reproducibility can be improved by filtering light having such spectrum through color filters to realize colors.

In an alternative embodiment, incident light may be short-wavelength light such as ultraviolet (“UV”) light, and three groups of wavelength conversion particles 22 for converting the wavelength of the short-wavelength light into blue, green and red wavelengths, respectively, may be provided in the wavelength conversion layer 20 to emit a white light.

In an embodiment, the wavelength conversion layer 20 may further include the scattering particles 23. The scattering particles 23 may be non-quantum dot particles with no wavelength conversion function. The scattering particles 23 scatter incident light and thus allow more of the incident light to be incident upon the wavelength conversion particles 22. In such an embodiment, the scattering particles 23 can uniformly control the emission angle of light of each wavelength. In such an embodiment, when light is incident upon the wavelength conversion particles 22 and is then wavelength-converted and emitted, the emitted light has a random scattering characteristic. If the scattering particles 23 are not provided in the wavelength conversion layer 20, green and red wavelengths emitted after colliding with the wavelength conversion particles 22 may have a scattering emission characteristic, but a blue wavelength emitted without colliding with the wavelength conversion particles 22 may not have a scattering emission characteristic. Thus, in this case, the emission amounts of blue, green, and red wavelengths may vary depending on the emission angle of the light. In an embodiment, the scattering particles 23 impart a scattering emission characteristic even to a blue wavelength emitted without colliding with the wavelength conversion particles 22, such that the emission angle of light of each wavelength may be uniformly controlled. In an embodiment, the scattering particles 23 ma include TiO₂ or SiO₂.

Referring back to FIG. 5, the passivation layer 30 is disposed on the wavelength conversion layer 20. In an embodiment, the bottom surface 30b of the passivation layer 30 may be in direct contact with the top surface 20a of the wavelength conversion layer 20. The passivation layer 30 effectively prevents the penetration of moisture and/or oxygen in to the wavelength conversion layer 20. The passivation layer 30 may include an inorganic material. I one embodiment, for example, the passivation layer 30 may include silicon nitride, aluminum nitride, zirconium nitride, titanium nitride, hafnium nitride, tantalum nitride, silicon oxide, aluminum oxide, titanium oxide, tin oxide, cerium oxide or silicon oxynitride, or may include a metal film having light transmittance. In one embodiment, for example, the passivation layer 30 may be formed of silicon nitride.

The passivation layer 30 may entirely or completely cover the wavelength conversion layer 20 from at least one side thereof. In one embodiment, for example, the passivation layer 30 may completely cover the wavelength conversion layer 20 from all sides thereof, but the disclosure is not limited thereto.

In an embodiment, the passivation layer 30 completely overlaps the wavelength conversion layer 20, covers the top surface 20a of the wavelength conversion layer 20, and further extends outwardly from the top surface 20a to cover the side surfaces 20s of the wavelength conversion layer 20. The passivation layer 30 may be in contact with the top surface 20a and the side surfaces 20s of the wavelength conversion layer 20. The passivation layer 30 extends even to the edge portions of the top surface 10a of the glass plate 10, exposed by the wavelength conversion layer 20, so that parts of the edge portions of the passivation layer 30 may be in direct contact with the top surface 10a of the glass plate 10. In an embodiment, the side surfaces 30s of the passivation layer 30 may be aligned with the side surfaces 10s of the glass plate 10.

The thickness of the passivation layer 30 may be less than the thickness of the wavelength conversion layer 20. The thickness of the passivation layer 30 may be in a range of about 0.1 micrometer (μm) and 2 μm. If the thickness of the passivation layer 30 is greater than or equal to 0.1 μm, the passivation layer 30 may exhibit a significant moisture/oxygen penetration preventing function. If the thickness of the passivation layer 30 is greater than 0.3 μm, the passivation layer 30 may provide an effective moisture/oxygen penetration preventing function. The passivation layer 30 may preferably have a thickness of 2 μm or less in terms of thinness and transmittance. In one embodiment, for example, the thickness of the passivation layer 30 may be about 0.4 μm. Here, the thickness of the passivation layer 30 may be defined as a thickness of a portion thereof overlapping the wavelength conversion layer 20 when viewed from a plan view in a thickness direction of the wavelength conversion layer 20.

The wavelength conversion layer 20, particularly, the wavelength conversion particles 22 included in the wavelength conversion layer 20, are vulnerable to moisture/oxygen. In a conventional wavelength conversion film, barrier films are typically laminated on the top and bottom surfaces of a wavelength conversion layer to prevent the penetration of moisture/oxygen into the wavelength conversion layer. In an embodiment, as shown in FIGS. 3 through 6, the wavelength conversion layer 20 is disposed with no barrier films, a sealing structure for protecting the wavelength conversion layer 20 is desired. This sealing structure may be realized by the passivation layer 30 and the glass plate 10. In such an embodiment, the glass plate 10 may be formed of an inorganic material such as glass, as described above, and the glass plate 10 may seal the wavelength conversion layer 20 through inorganic-inorganic bonding with the passivation layer 30.

In some embodiments, where the glass plate 10 is formed of an organic material, moisture may move within the glass plate 10, and as a result, moisture and/or oxygen may penetrate the wavelength conversion layer 20 through the bottom surface 20b of the wavelength conversion layer 20. In such embodiments, a barrier layer may be further disposed between the glass plate 10 and the wavelength conversion layer 20, thereby preventing the penetration of moisture and/or oxygen through the bottom surface 20b of the wavelength conversion layer 20.

The barrier layer may include an inorganic material. In one embodiment, for example, the barrier layer may include silicon nitride, aluminum nitride, zirconium nitride, titanium nitride, hafnium nitride, tantalum nitride, silicon oxide, aluminum oxide, titanium oxide, tin oxide, cerium oxide, or silicon oxynitride or may include a metal film having light transmittance. In one embodiment, for example, the barrier layer may include or be formed of a same material as the passivation layer 30, but the disclosure is not limited thereto.

The passivation layer 30 may be formed by, for example, a deposition method. In one embodiment, for example, the passivation layer 30 may be formed by performing a chemical vapor deposition method on the glass plate 10 where the wavelength conversion layer 20 is formed, but the disclosure is not limited thereto. Alternatively, various other deposition methods may be used to form the passivation layer 30.

In an embodiment, as described above, the optical member 100 may include a plurality of wavelength conversion members 11, and the wavelength conversion members 11 may perform a wavelength conversion function as a single integral member. Accordingly, the assembly of the display device 1000 may be simplified. In such an embodiment, since the wavelength conversion layer 20 of each of the wavelength conversion members 11 is sealed with passivation layer 30, the deterioration of the wavelength conversion layer 20 of each of the wavelength conversion members 11 may be effectively prevented.

Referring back to FIG. 4, the lower film 50 may be in the form of a thin film whose top and bottom surfaces are parallel to each other. The lower film 50 may be a supporting member that supports the wavelength conversion members 11 included in the optical member 100. The lower film 50, which is a flexible film, may expand or shrink in accordance with the curvature of the optical member 100. An adhesive member (not illustrated) may be applied on the top surface of the lower film 50 to allow the lower film 50 to be attached to the bottom surfaces 11b of the wavelength conversion member 11. The adhesive member may include a transparent adhesive material such as an optically clear resin (“OCR”) or an optically clear adhesive (“OCA”).

The lower film 50 may also serve as a diffusion film for improving the luminance uniformity of light incident from the light source module 400 to the optical member 100. In an embodiment, where the light source module 400 is disposed below the optical member 100, the lower film 50 may be a diffusion film capable of evenly diffusing incident light.

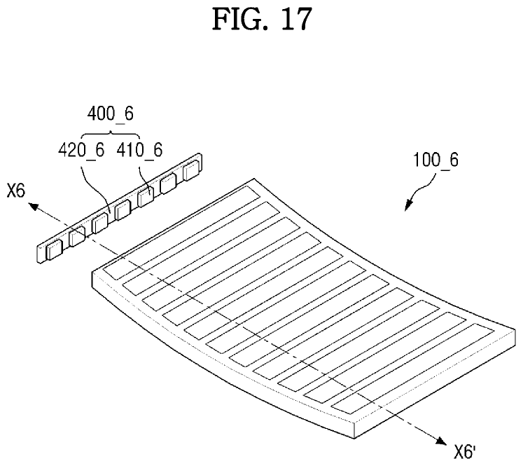

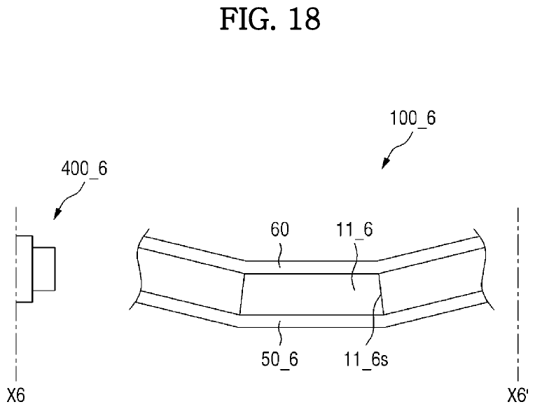

In some embodiments, the light source module 400 may be disposed adjacent to one side surface (rather than the bottom surface) of the optical member 100. In such embodiments, the lower film 50 may serve as a reflective film for upwardly reflecting light directed downwardly, among beams of light incident into the optical member 100, and this will be described later in greater detail with reference to FIGS. 17 and 18.

The upper film 60 may be in the form of a thin film whose top and bottom surfaces are parallel to each other. The upper film 60 may be disposed on the wavelength conversion members 11 and may be a protective member for fixing and protecting the wavelength conversion members 11, which are disposed in accordance with a predetermined curvature. An adhesive member may be applied on the bottom surface of the upper film 60 to allow the upper film 60 to be attached to the top surfaces 11a of the wavelength conversion members 11. In one embodiment, for example, the upper film 60 may be a polyethylene terephthalate (“PET”) film. The material of the upper film 60 is not particularly limited as long as it is flexible and transparent and is capable of transmitting light therethrough and preventing the penetration of moisture and/or oxygen.

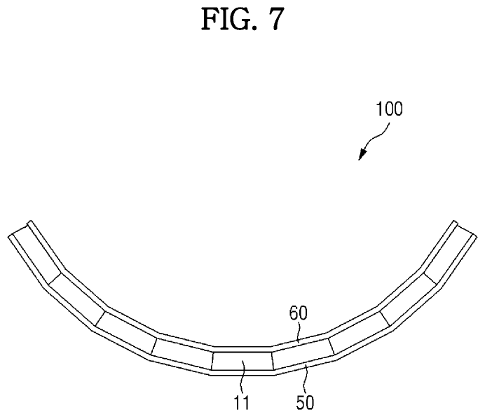

FIG. 7 is a cross-sectional view illustrating the optical member of FIG. 3 in a bent state.

Referring to FIG. 7, an embodiment of the optical member 100 may include the lower film 50, the upper film 60, and the wavelength conversion members 11, which are disposed between the lower and upper films 50 and 60.

In such an embodiment, as described above, the wavelength conversion members 11 of the optical member 100 may be disposed and attached on the lower film 50 to have a predetermined curvature. The upper film 60 may be attached on the wavelength conversion members 11, which are disposed to have a predetermined curvature. In such an embodiment, the bottom surfaces 11b and the top surfaces 11a of the wavelength conversion members 11 may be attached to the top surface of the lower film 50 and the bottom surface of the upper film 60, respectively, so that the wavelength conversion members 11 may be fixed to have a predetermined curvature.

The wavelength conversion members 11 may be in contact with one another on the sides thereof in the process of forming curvature with the wavelength conversion members 11.

In a case where the optical member 100 consists of a single plate, rather than multiple plates, the optical member 100 may be damaged if a high curvature structure is applied to the optical member 100. As a result, defect rates may increase during the manufacture of the display device 1000.

Also, since there is a limit in reducing the thickness of an optical member 100 having a high curvature structure, the design freedom of the display device 1000 may be limited. Specifically, if the optical member 100 is too thick, curvature may not be properly formed in the optical member 100. On the other hand, if the optical member 100 is too thin, the optical member 100 may easily be damaged.

In an embodiment of FIG. 7, since the optical member 100 includes the wavelength conversion members 11, damage to the optical member 100 may not be caused even when the optical member 100 is bent to have a high curvature, and as a result, a high curvature structure may be applied to the optical member 100 regardless of the thickness of the optical member 100. In such an embodiment, an ultra-high curvature structure of 1000 R or less may be applied to the optical member 100.

In an embodiment, when an optical member 100 having a large area is fabricated for a large-area display device 1000, no additional equipment for fabricating a large-area optical member 100 is desired because the optical member 100 is fabricated by properly arranging the wavelength conversion members 11, and as a result, the manufacturing cost of the optical member 100 may be reduced.

Alternative embodiments of the optical member according to the disclosure will hereinafter be described. In FIGS. 3 through 14, like reference numerals indicate like elements, and any repetitive detailed descriptions thereof will be omitted.

The embodiments of FIGS. 8 through 11 differ from the embodiment of FIGS. 3 and 4 in the cross-sectional shape of wavelength conversion members. The embodiments of FIGS. 8 through 11 will hereinafter be described, focusing mainly on the difference(s) with the embodiment of FIGS. 3 and 4.

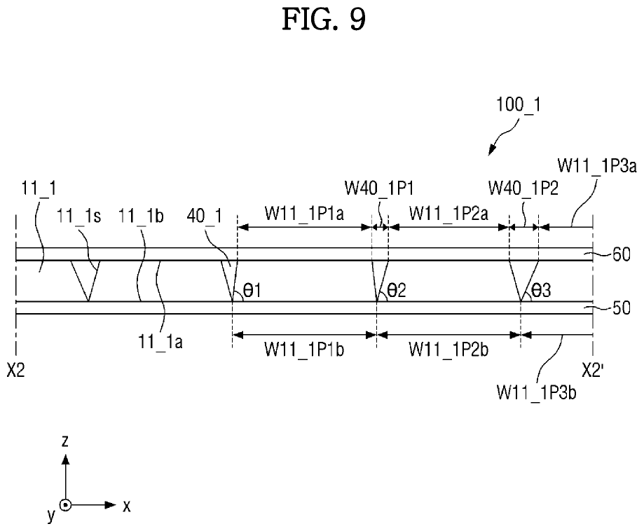

FIG. 8 is a plan view of an optical member according to an alternative embodiment of the disclosure. FIG. 9 is a cross-sectional view taken along line X2-X2′ of FIG. 8.

Referring to FIGS. 8 and 9, an embodiment of an optical member 100_1 may include a plurality of wavelength conversion members 11_1, a lower film 50 disposed below the wavelength conversion members 11_1, and an upper film 60 disposed above the wavelength conversion members 11_1. An air layer 40_1 may be formed between the wavelength conversion members 11_1. The air layer 40_1 may disappear or shrink in response to the optical member 100_1 being bent to have curvature.

Top surfaces 11_1a of the wavelength conversion members 11_1 may be in contact with the upper film 60, and an adhesive member (not illustrated) may be disposed between the top surfaces 11_1a and the upper film 60 to attach and fix them together. Bottom surfaces 11_1b of the wavelength conversion members 11_1 may be in contact with the lower film 50, and an adhesive member (not illustrated) may be disposed between the bottom surfaces 11_1b and the lower film 50 to attach and fix them together. Side surfaces 11_1s may be disposed between, and inclined with respect to, the top and bottom surfaces 11_1a and 11_1b of each of the wavelength conversion members 11_1. The inclination or inclined angle that the side surfaces 11_1s form with the top and bottom surfaces 11_1a and 11_1b of each of the wavelength conversion members 11_1 may differ from one wavelength conversion member 11_1 to another wavelength conversion member 11_1. In one embodiment, for example, the inclination that the side surfaces 11_1s form with the top and bottom surfaces 11_1a and 11_1b of each of the wavelength conversion members 11_1 may gradually decrease from the center to either side of the optical member 100_1.

The wavelength conversion members 11_1 may be spaced apart from one another in the first direction x and may be disposed to extend along the second direction y. The area of the top surfaces 11_1a of the wavelength conversion members 11_1, which are disposed on the lower film 50, may decrease from the center to either side of the optical member 100_1. In such an embodiment, the width of the top surfaces 11_1a of the wavelength conversion members 11_1 may decrease from the center to either side of the optical member 100_1.

In an embodiment where a first wavelength conversion member 11_1P1 is arranged at the center of the optical member 100_1 and second and third wavelength conversion members 11_1P2 and 11_1P3 are sequentially arranged next to the first wavelength conversion member 11_1P1, a width W11_1P1a of the top surface of the first wavelength conversion member 11_1P1 may be greater than a width W11_1P2a of the top surface of the second wavelength conversion member 11_1P2, which is disposed next to the first wavelength conversion member 11_1P1, and the width W11_1P2a of the top surface of the second wavelength conversion member 11_1P2 may be greater than a width W11_1P3a of the top surface of the third wavelength conversion member 11_1P3, which is disposed next to the second wavelength conversion member 11_1P2. In such an embodiment, the first wavelength conversion member 11_1P1, which is disposed at the center of the optical member 100_1, may have a largest top surface width, i.e., the width W11_1P1a, and the width of the top surfaces 11_1a of the wavelength conversion members 11_1 may gradually decrease from the center to either side of the optical member 100_1.

In such an embodiment where the top surfaces 11_1a of the wavelength conversion members 11_1 have different widths, the top surfaces 11_1a of the wavelength conversion members 11_1 may be spaced apart from one another by different distances. In such an embodiment, a first distance W40_1P1 between the top surfaces of the first and second wavelength conversion members 11_1P1 and 11_1P2 may be smaller than a second distance W40_1P2 between the top surfaces of the second and third wavelength conversion members 11_1P2 and 11_1P3.

In such an embodiment, widths W11_1P1b, W11_1P2b, and W11_1P3b of the bottom surfaces of the first, second, and third wavelength conversion members 11_1P1, 11_1P2, and 11_1P3 may all be the same as each other. Accordingly, the number of the wavelength conversion members 11_1 of the optical member 100_1 of FIGS. 8 and 9 may be substantially the same as the number of the wavelength conversion members 11 in the optical member 100 of FIG. 4 when the sizes of the optical member 100 of FIG. 4 and of the optical member 100_1 of FIGS. 8 and 9 are substantially the same as each other.

In such an embodiment, as described above, the inclination that the side surfaces 11_1s form with the top and bottom surfaces 11_1a and 11_1b of each of the wavelength conversion members 11_1 may differ from one wavelength conversion member 11_1 to another wavelength conversion member 11_1. In one embodiment, for example, a first angle θ1 that the side surfaces and the bottom surface of the first wavelength conversion member 11_1P1 form in the first direction x may be greater than a second angle θ2 that the side surfaces and the bottom surface of the second wavelength conversion member 11_1P2 form in the first direction x, and the second angle θ2 may be greater than a third angle θ3 that the side surfaces and the bottom surface of the third wavelength conversion member 11_1P3 form in the first direction x.

In such an embodiment where the top surfaces 11_1a of the wavelength conversion members 11_1 have different widths, the curvature of the optical member 100_1 may not be uniform, but may differ from one area to another area of the optical member 100_1, when the optical member 100_1 is bent to have curvature. In one embodiment, for example, wavelength conversion members 11_1 at or near the center of the optical member 100_1 that have relatively wide top surfaces may form a gentle curvature, and the curvature of the optical member 100_1 may become steeper from the center to either side of the optical member 100_1. In such an embodiment, the optical member 100_1 may become more curved at either side thereof than at the center thereof. A display device 1000 having a greater curvature at either side thereof than at the center thereof can enhance a user's feeling of emersion and can effectively provide information to the user.

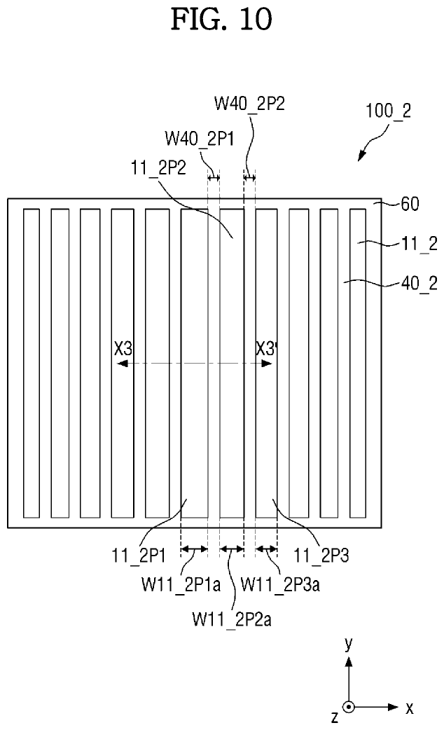

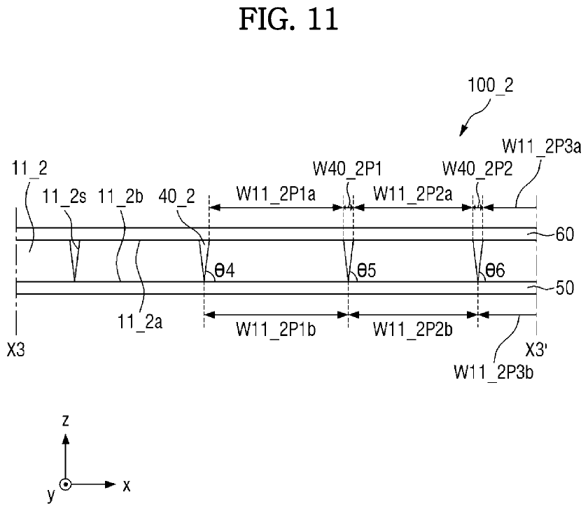

FIG. 10 is a plan view of an optical member according to another alternative embodiment of the disclosure. FIG. 11 is a cross-sectional view taken along line X3-X3′ of FIG. 10.

Referring to FIGS. 10 and 11, an embodiment of an optical member 100_2 may include a plurality of wavelength conversion members 11_2, a lower film 50 disposed below the wavelength conversion members 11_2, and an upper film 60 disposed above the wavelength conversion members 11_2. An air layer 40_2 may be formed between the wavelength conversion members 11_2. The air layer 40_2 may disappear or shrink in response to the optical member 100_1 being bent to have curvature.

Top surfaces 11_2a of the wavelength conversion members 11_2 may be in contact with the upper film 60, and an adhesive member (not illustrated) may be disposed between the top surfaces 11_2a and the upper film 60 to attach and fix them together. Bottom surfaces 11_2b of the wavelength conversion members 11_2 may be in contact with the lower film 50, and an adhesive member (not illustrated) may be disposed between the bottom surfaces 11_2b and the lower film 50 to attach and fix them together. Side surfaces 11_2s may be disposed between, and inclined with respect to, the top and bottom surfaces 11_2a and 11_2b of each of the wavelength conversion members 11_2. The inclination that the side surfaces 11_2s form with the top and bottom surfaces 11_2a and 11_2b of each of the wavelength conversion members 11_2 may be the same among all the wavelength conversion members 11_2.

The wavelength conversion members 11_2 may be spaced apart from one another in the first direction x and may be disposed to extend along the second direction y. The general width of the wavelength conversion members 11_2, which are disposed on the lower film 50, may decrease from the center to either side of the optical member 100_2. In such an embodiment, the width of the top surfaces 11_2a of the wavelength conversion members 11_2 and the width of the bottom surfaces 11_2b of the wavelength conversion members 11_2 may decrease from the center to either side of the optical member 100_2.

In an embodiment where a fourth wavelength conversion member 11_2P1 is arranged at the center of the optical member 100_2 and fifth and sixth wavelength conversion members 11_2P2 and 11_2P3 are sequentially arranged next to the fourth wavelength conversion member 11_2P1, a width W11_2P1a of the top surface of the fourth wavelength conversion member 11_2P1 may be greater than a width W11_2P2a of the top surface of the fifth wavelength conversion member 11_2P2, which is disposed next to the fourth wavelength conversion member 11_2P1, and the width W11_2P2a of the top surface of the fifth wavelength conversion member 11_2P2 may be greater than a width W11_2P3a of the top surface of the sixth wavelength conversion member 11_2P3, which is disposed next to the fifth wavelength conversion member 11_2P2. That is, the fourth wavelength conversion member 11_2P1, which is disposed at the center of the optical member 100_2, may have a largest top surface width, i.e., the width W11_2P1a, and the width of the top surfaces 11_2a of the wavelength conversion members 11_2 may gradually decrease from the center to either side of the optical member 100_2.

In such an embodiment, a width W11_2P1b of the bottom surface of the fourth wavelength conversion member 11_2P1 may be greater than a width W11_2P2b of the bottom surface of the fifth wavelength conversion member 11_2P2, and the width W11_2P2b of the bottom surface of the fifth wavelength conversion member 11_2P2 may be greater than a width W11_2P3b of the bottom surface of the sixth wavelength conversion member 11_2P3. That is, the fourth wavelength conversion member 11_2P1, which is disposed at the center of the optical member 100_2, may have a largest bottom surface width, i.e., the width W11_2P1b, and the width of the bottom surfaces 11_2b of the wavelength conversion members 11_2 may gradually decrease from the center to either side of the optical member 100_2.

The rate at which the width of the top surfaces 11_2a of the wavelength conversion members 11_2 decreases may be the same as the rate at which the width of the bottom surfaces 11_2b of the wavelength conversion members 11_2 decreases. Thus, the inclination that the side surfaces 11_2s and the top and bottom surfaces 11_2a and 11_2b of each of the wavelength conversion members 11_2 form may be the same among all the wavelength conversion members 11_2. That is, a fourth angle θ4 that the side surfaces and the bottom surface of the fourth wavelength conversion member 11_2P1 form in the first direction x, a fifth angle θ5 that the side surfaces and the bottom surface of the fifth wavelength conversion member 11_2P2 form in the first direction x, and a sixth angle θ6 that the side surfaces and the bottom surface of the sixth wavelength conversion member 11_2P3 form in the first direction x may all be the same as each other.

In an embodiment where the inclination that the side surfaces 11_2s and the top and bottom surfaces 11_2a and 11_2b of each of the wavelength conversion members 11_2 form is the same among all the wavelength conversion members 11_2, the distance between the top surfaces 11_2a of the wavelength conversion members 11_2 may also be the same among all the wavelength conversion members 11_2. In such an embodiment, a third distance W40_2P1 between the top surfaces of the fourth and fifth wavelength conversion members 11_2P1 and 11_2P2 may be the same as a second distance W40_2P2 between the top surfaces of the fifth and sixth wavelength conversion members 11_2P2 and 11_2P3.

Since the general width of the wavelength conversion members 11_2 decreases from the center to either side of the optical member 100_2, more wavelength conversion members 11_2 can be arranged in a given area of the optical member 100_2 of FIGS. 10 and 11 than in the same given area of the optical member 100 of FIG. 4.

In an embodiment where the wavelength conversion members 11_2 have different general widths, the curvature of the optical member 100_2 may not be uniform, but may differ from one area to another area of the optical member 100_2, as in the embodiment of FIGS. 8 and 9, when the optical member 100_2 is bent to have curvature. In one embodiment, for example, wavelength conversion members 11_2 at or near the center of the optical member 100_2 that are relatively wide may form a gentle curvature, and the curvature of the optical member 100_2 may become steeper from the center to either side of the optical member 100_2. In such an embodiment, the optical member 100_2 may become more curved at either side thereof than at the center thereof. A display device 1000 having a greater curvature at either side thereof than at the center thereof may enhance the user's feeling of emersion and can effectively provide information to the user.

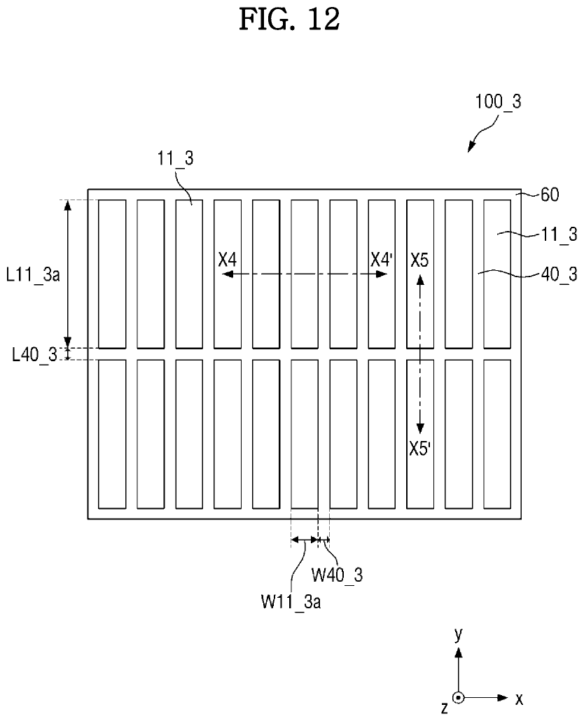

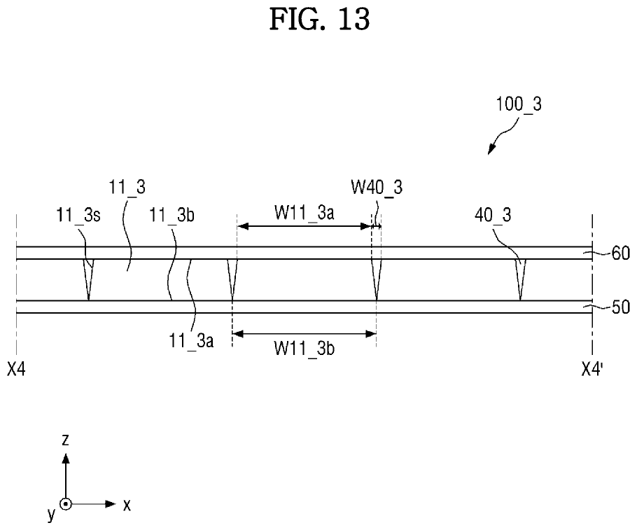

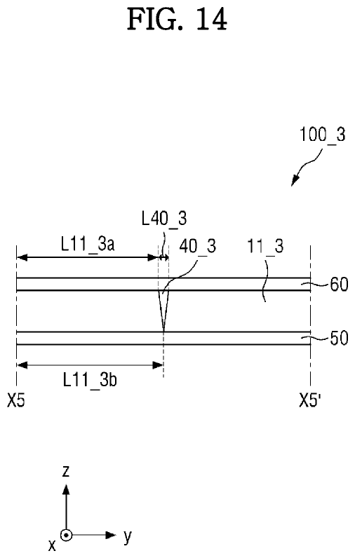

FIG. 12 is a plan view of an optical member according to another alternative embodiment of the disclosure. FIG. 13 is a cross-sectional view taken along line X4-X4′ of FIG. 12. FIG. 14 is a cross-sectional view taken along line X5-X5′ of FIG. 12.

The embodiment of FIGS. 12 through 14 differs from the embodiment of FIGS. 3 and 4 in that wavelength conversion members 11_3 are spaced apart from one another not only in the first direction x, but also in the second direction y. The embodiment of FIGS. 12 through 14 will hereinafter be described, focusing mainly on the difference(s) with the embodiment of FIGS. 3 and 4.

Referring to FIGS. 12 through 14, an embodiment of an optical member 100_3 may include a plurality of wavelength conversion members 11_3, a lower film 50 disposed below the wavelength conversion members 11_3, and an upper film 60 disposed above the wavelength conversion members 11_3. An air layer 40_3 may be formed between the wavelength conversion members 11_3. The air layer 40_3 may disappear or shrink in response to the optical member 100_3 being bent to have curvature.

Top surfaces 11_3a of the wavelength conversion members 11_3 may be in contact with the upper film 60, and an adhesive member (not illustrated) may be disposed between the top surfaces 11_3a and the upper film 60 to attach and fix them together. Bottom surfaces 11_3b of the wavelength conversion members 11_3 may be in contact with the lower film 50, and an adhesive member (not illustrated) may be disposed between the bottom surfaces 11_3b and the lower film 50 to attach and fix them together. Side surfaces 11_3s may be disposed between, and inclined with respect to, the top and bottom surfaces 11_3a and 11_3b of each of the wavelength conversion members 11_3.

The wavelength conversion members 11_3 may be spaced apart from one another not only in the first direction x, but also in the second direction y. FIG. 12 illustrates an embodiment where a total of 22 wavelength conversion members 11_3 are arranged in two rows and eleven columns, but the disclosure is not limited thereto. In such an embodiment, the wavelength conversion members 11_3 may be arranged in two or more rows along the second direction y.

The wavelength conversion members 11_3 may have the same shape as each other, but the disclosure is not limited thereto. Alternatively, the wavelength conversion members 11_3 may have different shapes like the wavelength conversion members 11_1 of FIGS. 8 and 9 or the wavelength conversion members 11_2 of FIGS. 10 and 11.

In an embodiment where the wavelength conversion members 11_3 have the same shape, the top surfaces 11_3a of the wavelength conversion members 11_3 may have the same width, i.e., a width W11_3a, in the first direction x, and the bottom surfaces 11_3b of the wavelength conversion members 11_3 may have the same width, i.e., a width W11_3b, in the first direction x. In such an embodiment, the top surfaces 11_3a of the wavelength conversion members 11_3 may have the same width, i.e., a width L11_3a, in the second direction y, and the bottom surfaces 11_3b of the wavelength conversion members 11_3 may have the same width, i.e., a width L11_3b, in the second direction y.

Each of the wavelength conversion members 11_3 generally extend in the second direction y and may thus have long sides and short sides having a different length from the long sides. In one embodiment, for example, the width L11_3a, in the second direction y, of the top surfaces 11_3a and the width L11_3b, in the second direction y, of the bottom surfaces 11_3b may be greater than the width W11_3a, in the first direction x, of the top surfaces 11_3a and the width W11_3b, in the first direction x, of the bottom surfaces 11_3b, respectively, but the disclosure is not limited thereto. Alternatively, the width L11_3a, in the second direction y, of the top surfaces 11_3a and the width L11_3b, in the second direction y, of the bottom surfaces 11_3b may be smaller than the width W11_3a, in the first direction x, of the top surfaces 11_3a and the width W11_3b, in the first direction x, of the bottom surfaces 11_3b, respectively.

In an embodiment where the wavelength conversion members 11_3 all have the same shape as each other, the distance, in the first direction x, between the top surfaces 11_3a of the wavelength conversion members 11_3 may be the same as a distance W40_3 among all the wavelength conversion members 11_3, and the distance, in the second direction y, between the top surfaces 11_3a of the wavelength conversion members 11_3 may be the same as a distance L40_3 among all the wavelength conversion members 11_3. However, the distance W40_3 may be different from the distance L40_3. In one embodiment, the distance W40_3 may be greater than the distance L40_3, but the disclosure is not limited thereto. Alternatively, the distance L40_3 may be greater than, or the same as, the distance W40_3 depending on the curvature of the optical member 100_3.

In an embodiment where the wavelength conversion members 11_3 are spaced apart from one another not only in the first direction x, but also in the second direction y, curvature can be formed not only about a central axis along the second direction y, but also about a central axis along the first direction x. In such an embodiment, the optical member 100_3 can be fabricated into various shapes, and as a result, the display device 1000 can be fabricated into various shapes without restriction from the viewpoint of design.

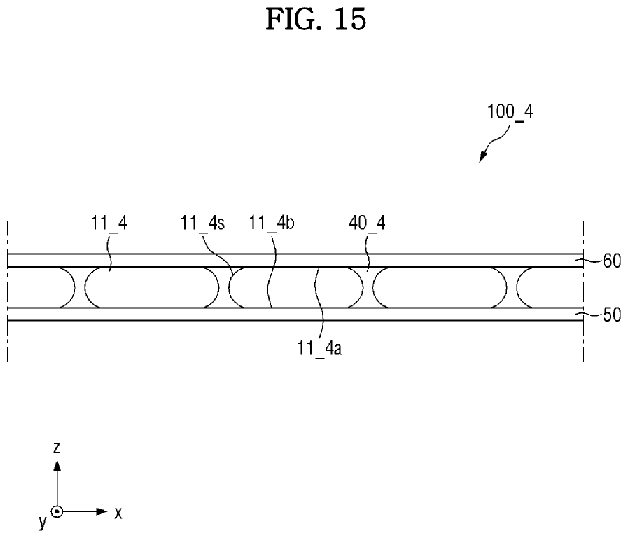

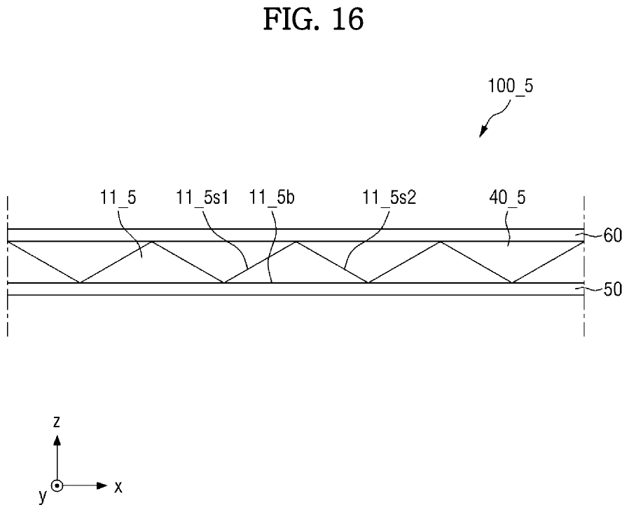

FIGS. 15 and 16 are cross-sectional views of wavelength conversion members according to alternative embodiments of the disclosure. Specifically, FIGS. 15 and 16 are cross-sectional view taken along line X1-X1′ of FIG. 3. The embodiments of FIGS. 15 and 16 differ from the embodiment of FIG. 4 in that wavelength conversion members 11_4 or 11_5 may have various shapes other than a trapezoidal shape. The embodiments of FIGS. 15 and 16 will hereinafter be described, focusing mainly on the difference(s) with the embodiment of FIG. 4.

Referring to FIG. 15, an embodiment of an optical member 100_4 may include a plurality of wavelength conversion members 11_4, a lower film 50 disposed below the wavelength conversion members 11_4, and an upper film 60 disposed above the wavelength conversion members 11_4. An air layer 40_4 may be formed between the wavelength conversion members 11_4. The air layer 40_4 may disappear or shrink in response to the optical member 100_4 being bent to have curvature.

Top surfaces 11_4a of the wavelength conversion members 11_4 may be in contact with the upper film 60, and an adhesive member (not illustrated) may be disposed between the top surfaces 11_4a and the upper film 60 to attach and fix them together. Bottom surfaces 11_4b of the wavelength conversion members 11_4 may be in contact with the lower film 50, and an adhesive member (not illustrated) may be disposed between the bottom surfaces 11_4b and the lower film 50 to attach and fix them together. Side surfaces 11_4s that are partially curved may be disposed between, and inclined with respect to, the top and bottom surfaces 11_4a and 11_4b of each of the wavelength conversion members 11_4. Pairs of side surfaces 11_4s of the wavelength conversion members 11_4 may be spaced apart from one another, but the disclosure is not limited thereto. Alternatively, the pairs of side surfaces 11_4s of the wavelength conversion members 11_4 may be at least partially in contact with one another.

In an embodiment where the pairs of side surfaces 11_4s of the wavelength conversion members 11_4 include curved surfaces, damage that may be caused between the wavelength conversion members 11_4 when the optical member 100_4 is bent to have curvature may be effectively prevented. In such an embodiment, defect rates during the fabrication of the optical member 100_4 can be further reduced.

Referring to FIG. 16, an optical member 100_5 may include a plurality of wavelength conversion members 11_5, a lower film 50 disposed below the wavelength conversion members 11_5, and an upper film 60 disposed above the wavelength conversion members 11_5. An air layer 40_5 may be formed between the wavelength conversion members 11_5. The air layer 40_4 may disappear or shrink in response to the optical member 100_5 being bent to have curvature.

In an embodiment, as shown in FIG. 16, the wavelength conversion members 11_5 may not include top surfaces 11_5 and may include bottom surfaces 11_5b and first side surfaces 11_5s1 and second side surfaces 11_5s2 that are in contact with the bottom surface 11_5b. In such an embodiment, the wavelength conversion members 11_5 may have a triangular shape in a cross-sectional view. The bottom surfaces 11_5b of the wavelength conversion members 11_5 may be in contact with the lower film 50, and an adhesive member (not illustrated) may be disposed between the bottom surfaces 11_5b and the lower film 50 to attach and fix them together.

The first side surfaces 11_5s1 and the second side surfaces 11_5s2 of the wavelength conversion members 11_5 may be at least partially in contact with the upper film 60. The upper film 60 may generally cover and protect the wavelength conversion members 11_5. An adhesive member may be disposed on the bottom surface of the upper film 60 and may thus fix the optical member 100_5 to have curvature.

In an embodiment where the wavelength conversion members 11_5 do not include top surfaces and include the first side surfaces 11_5s1 and the second side surfaces 11_5s2, a greater curvature may be applied to the optical member 100_5. In such an embodiment, since a large amount of air layer 40_5 can be formed between the wavelength conversion members 11_5, the optical member 100_5 may be further bent.

FIG. 17 is a perspective view of an optical member according to another alternative embodiment of the disclosure. FIG. 18 is a cross-sectional view taken along line X6-X6′ of FIG. 17.

In an embodiment, as described above with reference to FIG. 2, the light source module 400 is disposed below the optical member 100 to provide light toward the display panel 300. In an alternative embodiment, as shown in FIGS. 17 and 18, a light source module 400_6 is disposed on a side surface of an optical member 100_6 to provide light toward the optical member 100_6. The embodiment of FIGS. 17 and 18 is almost the same as, or at least similar to, the embodiment of FIG. 2, except for the light source module 400_6 and the optical member 100_6, and thus will hereinafter be described, focusing mainly on the differences with the embodiment of FIG. 2.

Referring to FIGS. 17 and 18, the light source module 400_6 may be disposed adjacent to a side surface of the optical member 100_6. The light source module 400_6 may provide light toward the optical member 100_6, and the optical member 100_6 may be provided the light from the light source module 400_6.

The light source module 400_6 may include LED light sources 410_6 and a printed circuit board 420_6 on which the LED light sources 410_6 are mounted. The LED light sources 410_6 are illustrated in FIGS. 17 and 18 as being disposed adjacent to one short-side surface of the optical member 100_6, but the disclosure is not limited thereto. Alternatively, the LED light sources 410_6 may be disposed adjacent to both short-side surfaces of the optical member 100_6 or adjacent to one or both long-side surfaces of the optical member 100_6. The LED light sources 410_6 may be top emission LEDs that emit light through the top surfaces thereof. The printed circuit board 420_6 may be disposed on a sidewall of the lower storage container 500 of FIG. 2.

The optical member 100_6 may guide light provided by the light source module 400_6 and may thus emit light upwardly. In the process of emitting light upwardly, the optical member 100_6 may convert the wavelength of light incident thereinto and may emit the wavelength-converted light. That is, the optical member 100_6 may provide light toward the display panel 300 of FIG. 2 by performing both a light guide function and a wavelength conversion function at the same time.

For an efficient light guide, side surfaces 11_6s of the optical member 100_6 may be in contact with one another. Although not specifically illustrated, a lower film 50_6 may further include a reflective film or a reflective coating layer. The lower film 50_6 of the optical member 100_6 not only can adhere and fix wavelength conversion members 11_6 to each other, but also can upwardly reflect light directed downward, among beams of light traveling within the optical member 100_6.

In an embodiment where the light source module 400_6 is disposed adjacent to one side surface of the optical member 100_6, rather than below the optical member 100_6, the general thickness of the display device 1000 can be reduced, and the manufacturing cost of the display device 1000 can be lowered by reducing the number of the LED light sources 410_6.

While the invention has been particularly shown and described with reference to exemplary embodiments thereof, it will be understood by those of ordinary skill in the art that various changes in form and details may be made therein without departing from the spirit or scope of the invention as defined by the following claims.

What is claimed is:

1. An optical member comprising:
a first film;
a second film disposed to face the first film in a thickness direction; and
a plurality of wavelength conversion members disposed between the first and second films and arranged in a direction perpendicular to the thickness direction, wherein each of the wavelength conversion members has flat surfaces,
wherein the flat surfaces of at least two of the wavelength conversion members are not parallel to each other.

2. The optical member of claim 1, wherein
the flat surfaces include a bottom surface in contact with the first film and a top surface in contact with the second film and facing the bottom surface, and
an area of the bottom surface is larger than an area of the top surface.

3. The optical member of claim 2, wherein
each of the wavelength conversion members includes a side surface disposed between, and at an inclination with respect to, the top and bottom surfaces, and
an angle between the bottom surface and the side surface is an acute angle.

4. The optical member of claim 3, wherein each of the wavelength conversion members has a trapezoidal cross-sectional shape.

5. The optical member of claim 2, wherein
each of the wavelength conversion members includes a side surface disposed between the top and bottom surfaces, and
the side surface is at least partially curved.

6. The optical member of claim 1, wherein
the wavelength conversion members include a first wavelength conversion member and a second wavelength conversion member disposed adjacent to the first wavelength conversion member, and
an area of a top surface of the first wavelength conversion member is larger than an area of a top surface of the second wavelength conversion member.

7. The optical member of claim 6, wherein an area of a bottom surface of the first wavelength conversion member is the same as an area of a bottom surface of the second wavelength conversion member.

8. The optical member of claim 7, wherein a first angle between the bottom surface of the first wavelength conversion member and a side surface of the first wavelength conversion member is greater than a second angle between the bottom surface of the second wavelength conversion member and a side surface of the second wavelength conversion member.

9. The optical member of claim 6, wherein an area of a bottom surface of the first wavelength conversion member is larger than an area of a bottom surface of the second wavelength conversion member.

10. The optical member of claim 9, wherein a third angle between the bottom surface of the first wavelength conversion member and a side surface of the first wavelength conversion member is the same as a fourth angle between the bottom surface of the second wavelength conversion member and a side surface of the second wavelength conversion member form with each other.

11. An optical member comprising:
a first film;
a second film disposed to face the first film in a thickness direction; and
a plurality of wavelength conversion members disposed between the first and second films and arranged in a direction perpendicular to the thickness direction,
wherein the optical member includes a curved area which is bent to have curvature in at least a part thereof.

12. The optical member of claim 11, wherein each of the wavelength conversion members includes a glass plate and a wavelength conversion layer disposed on the glass plate.

13. The optical member of claim 12, wherein
each of the wavelength conversion members further includes a passivation layer, and
the wavelength conversion layer is disposed between the glass plate and the passivation layer.

14. The optical member of claim 11, further comprising:
an air layer between the wavelength conversion members.

15. The optical member of claim 14, wherein a volume of the air layer in the curved area is smaller than a volume of the air layer in an area other than the curved area.

16. The optical member of claim 15, wherein the greater the curvature of the curved area is, the smaller the volume of the air layer in the curved area.

17. An optical member comprising:
a lower film;
is an upper film disposed to face the lower film in a thickness direction;
a plurality of wavelength conversion members disposed between the lower and upper films and arranged in a direction perpendicular to the thickness direction, wherein each of the wavelength conversion members has flat surfaces;
a light source module disposed adjacent to the wavelength conversion members; and
a display panel disposed above the wavelength conversion members,
wherein
the flat surface of at least two of the wavelength conversion members are not parallel to each other, and
the flat surfaces of each of the wavelength conversion members include a bottom surface in contact with the lower film and a top surface in contact with the upper film and facing the bottom surface.

18. The optical member of claim 17, wherein
the light source module is disposed below the wavelength conversion members, and
the lower film diffuses light emitted from the light source module.

19. The optical member of claim 17, wherein
the light source module is disposed adjacent to a side surface of the wavelength conversion members, and
the lower film includes a reflective film or a reflective coating layer.

20. The optical member of claim 17, wherein
each of the wavelength conversion members includes a glass plate and a wavelength conversion layer disposed on the glass plate,
the light source module emits a blue light, and
the wavelength conversion layer includes first wavelength conversion particles which convert the blue light into a green light and second wavelength conversion particles which convert the blue light into a red light.
